(19) United States
(12) Patent Application Publication
(10) Pub. No.: US 2011/0223946 A1
(43) Pub. Date: Sep. 15, 2011

(54) Central Unit, Terminal Unit, System and Method for Downloading a Light Pattern

(75) Inventors: Jan Enenkel, Gratkorn (AT); Peter Trattler, Graz (AT); John Heugle, Seiersberg (AT)

(73) Assignee: austriamicrosystems AG, Unterpremstattaen (AT)

(21) Appl. No.: 13/059,921

(22) PCT Filed: Aug. 4, 2009
(86) PCT No.: PCT/EP2009/060109

§ 371 Date: May 9, 2011

(30) Foreign Application Priority Data
Aug. 19, 2008 (DE) 10 2008 038 340.6

(51) Int. Cl. H04W 4/12

(52) U.S. Cl. 455/466

(57) ABSTRACT

In one embodiment, a central unit, particularly for use in a network, has a memory (2) for at least one light pattern (L) that is suitable for running on a terminal device (5), a control logic (3) connected to the memory (2) and a communications interface (4) coupled to the control logic (3) for providing the at least one light pattern (L) for the terminal device (5). In one embodiment, a terminal device, particularly for use in a network, comprises a process control unit (10), a communications interface (11) connected to the process control unit (10) and that is set up for downloading at least one light pattern (L), and a memory (12) coupled to the process control unit (10) for storing the at least one light pattern (L). In one embodiment, a system for downloading a light pattern comprises a central unit (1), a terminal device (5) and a communications facility (7) for transmitting at least one light pattern (L) from a communications interface (4) of the central unit (1) to a communications interface (11) of the terminal device (5).

The present invention relates to central unit, particularly for use in a network, a terminal device, particularly for use in a network, a system and a method for downloading a light pattern.

In conventional terminal devices such as mobile telephones, so-called personal digital assistants, PDAs, or cordless game consoles, a user has the possibility of adapting the device to his needs and personal preferences to a certain extent. This can be done, for example, by setting personal backgrounds, during the idle state of the device for example, by adjusting the font size or the icons for application, or by selecting and installing ringtones and similar acoustic signals. To further improve the handling and operation of such terminal devices, it can be desirable to realize an improved and more flexible adaptation to user requirements, also including the lighting device already present in a terminal device.

One problem to be solved is to be able to undertake a configuration of the terminal device, in particular, its lighting device, remotely.

The problem is solved by the subject matter of the independent claims. Refinements and configurations are the subject matter of the dependent claims.

In one embodiment, a central unit, particularly for use in a network, has a memory for at least one light pattern, a control logic connected to the memory and a communications interface coupled to the control logic. The communications interface is set up to provide the at least one light pattern for a terminal device. The at least one light pattern is suitable for running on the terminal device.

The light pattern from the memory is provided by the control logic to the communications interface for the terminal to be run thereon.

By virtue of the fact that the light pattern of the central unit adjusts an already present lighting device of the terminal device, the terminal device is remotely configured via the communications interface of the central unit.

The central unit is realized as a computer or server, for example. The light pattern comprises a functional specification for converting a signal into a representation by means of light. The light can be monochromatic or polychromatic. Light refers in this case to the light emitted from a lighting device in the terminal device. The network is any desired communications network designed for communication between terminal device and central unit. The network is realized, for example as a mobile telephone network, a fixed network, the Internet or a combination of the aforesaid. The communications interface is designed in such a manner that it is suitable for a communication via a respective configuration of the network or enables the latter.

In a refinement, the central unit has a device connected to the control logic for creating or editing the at least one light pattern.

In combination with the control logic, this device enables the creation of individual light patterns. A light pattern created in this manner is in turn provided at the communications interface of the central unit for running on the terminal device. During the running, the light pattern controls the lighting unit in the terminal device, whereby defined lighting effects are achieved. It is additionally possible to modify already existing light patterns. These modifiable light patterns can be downloaded from the network. The downloaded data contain the light pattern and a definition of the possibilities for modification.

The creation of light patterns by a user advantageously allows an individual configuration of the terminal device that is particularly well adapted to the user's needs. Thereby the convenience of use is further enhanced.

In one embodiment a central unit, particularly for use in a network, comprises a process control unit, a communications interface connected to the process control unit and a memory coupled to the process control unit. The communications interface is set up to download at least one light pattern from the network. The memory is designed for storing the at least one light pattern. The terminal device is set up for executing the at least one light pattern.

The at least one light pattern is downloaded from the network with the aid of the communications interface and stored in the memory of the terminal device. Subsequently the light pattern is executed on the terminal device.

The light pattern downloaded from the network advantageously allows a configuration of the terminal device remotely, i.e., via the network.

The terminal device is a portable electronic device that can be located in the user's hand.

The lighting device comprises, for example, several light emitting diodes, LEDs. These could be configured as white LEDS, for example, or as polychromatic LEDS, according to the ROB, red-green-blue, color system for instance.

Downloading refers to the transmission of data from the central unit to the terminal device. This downloading can take place via the so-called Short Message Service, SMS, or the Multimedia Message Service, MMS, as a communications service or a communications channel. Alternatively, the downloading can take place directly with an Internet connection, via a so-called browser, for example. The communications interface of the terminal device is designed in such a manner that it can connect to the communications interface of the central unit via the network and exchange data.

In a refinement, the terminal device comprises a driver connected to the process control unit for providing a control signal for the lighting device, and a signal source coupled to the process control unit for providing a signal. In another embodiment, the control signal is provided as a function of an overlaying of the signal from the signal source with the light pattern from the memory.

The process control unit overlays the signal from the signal source with the downloaded light pattern from the memory. The driver thus provides the derived control signal to the lighting unit of the terminal device to control it.

The user can advantageously download different light patterns for different signal sources and configure them for the respective application case.

In another embodiment, the signal source comprises an audio unit and the signal comprises an audio signal.

The audio unit, e.g., a sound chip or a digital-to-analog converter, DAC, of the terminal device, provides a modulated signal such as an amplitude-modulated signal. The audio signal thus provided comprises, for example, a piece of music or a ringtone. The audio signal is linked to the light pattern, whereby the lighting device generates light effects matched to the audio signal. For the case where a terminal device has been put into “muted” mode, the ringtone for generating light effects with the light pattern is used, but not played back. Thus, events otherwise announced with acoustic signals are displayed individually in a relatively nondisruptive manner.

In a refinement, the signal source has a sensor. The signal comprises a sensor signal.

The sensor is realized as a motion or acceleration sensor. The sensor signal is linked to the light pattern and displayed by means of the lighting device of the terminal. This is particularly advantageous when running games on the terminal device, since the movements carried out with the terminal device are especially well visualized and thus support the user by the improved feedback.

In a refinement, the signal source comprises an event source. The signal comprises an event signal.

An event is, for example, an action that the user performs at the terminal by pressing the appropriate keys, moving a so-called joystick or operating a navigation key. This may be the initiation of a call, for example. An event may also be an announcement from the network that is received by the terminal device via its communications interface. This is, for example, the announcement of an incoming call or information about a new SMS or MMS.

By superimposing the light pattern on the event signal, such events can be distinguishably displayed optically on the terminal device by different light effects. For example, incoming calls can be displayed differently on the terminal device according to caller groups.

In a refinement, the terminal device is configured as portable device or a portable device with an attached computer.

The terminal device can also be configured as a device with a connected computer that takes over sub-functions of the terminal device, such as communication with the central device, during the downloading of the light pattern.

In one embodiment, a system for downloading a light pattern comprises a central unit, a terminal device and a communications facility for transmitting at least one light pattern from a communications interface of the central unit to a communications interface of the terminal device.

With the aid of the system, a light pattern is transmitted from the central unit to the terminal device and executed there.

Thus a lighting device of the terminal is advantageously individually configured remotely for different application cases. The flexibility of the terminal is thereby markedly increased even after its production and distribution. New user needs for operating the terminal device or visualizing events can be better met.

In one embodiment, a method for downloading a light pattern comprises the steps:
connecting a terminal device to a central unit via a communications facility,
selecting a light pattern stored in the central unit,
downloading the selected light pattern from the central unit to the terminal device via the communications facility, and
storing the downloaded light pattern on the terminal device.

The presence of at least one light pattern, i.e., several light patterns, makes it possible for a user to be able to select according to his taste between these patterns stored in the central unit.

In a refinement, the method comprises the following steps.
configuring the light pattern on the terminal device,
linking the light pattern to a signal from a signal source and generating a control signal for a lighting device of the terminal device.

The control signal is generated as a function of a superimposition of the light pattern on the signal.

Configuring the light pattern comprises adjusting the light pattern for a given application case. For example, one light pattern is linked to the event “incoming call,” and another to the movement of a scroll wheel.

In another embodiment, the method comprises the creation of an additional light pattern.

A user can thus create or edit additional light patterns according to his own ideas on the central unit and then download them via the network.

In another embodiment, the invention comprises a computer program product having at least one light pattern, as well as program code for realizing the above-described functions of the central unit's control logic.

The invention will be described in detail below for several exemplary embodiments with reference to the figures. Functional elements with identical function or effect bear identical reference numbers. Insofar as elements correspond to one another in function, a description of them will not be repeated in each of the following figures. Therein:

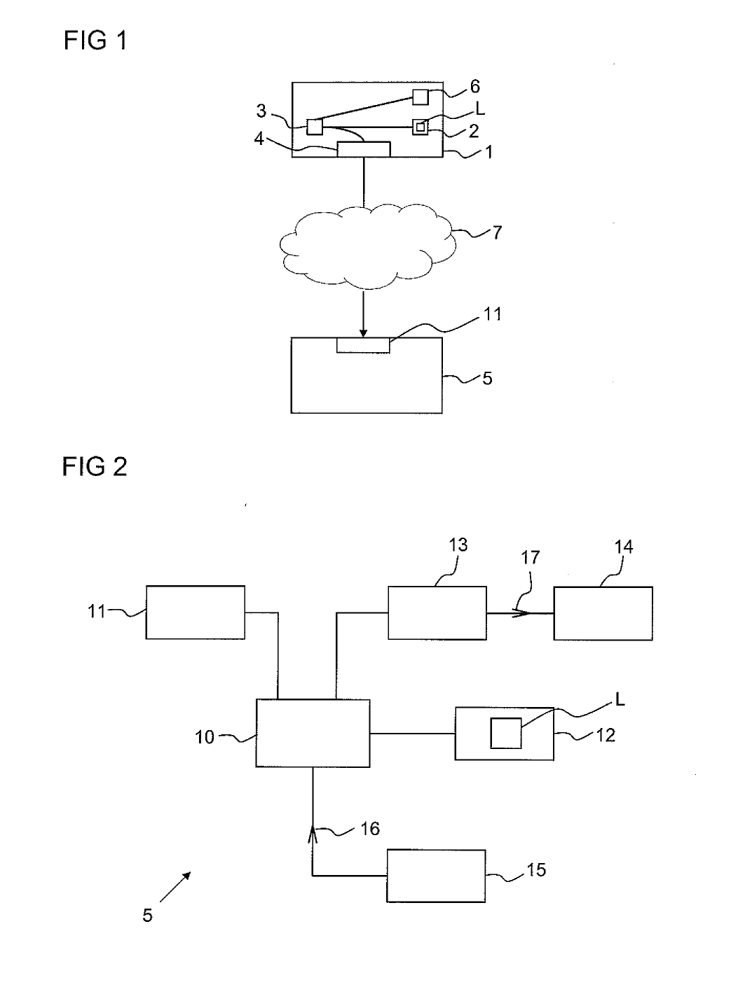

FIG. 1 shows an exemplary embodiment of a system for downloading a light pattern according to the proposed principle,

FIG. 2 shows an exemplary embodiment of a terminal device according to the proposed principle, and

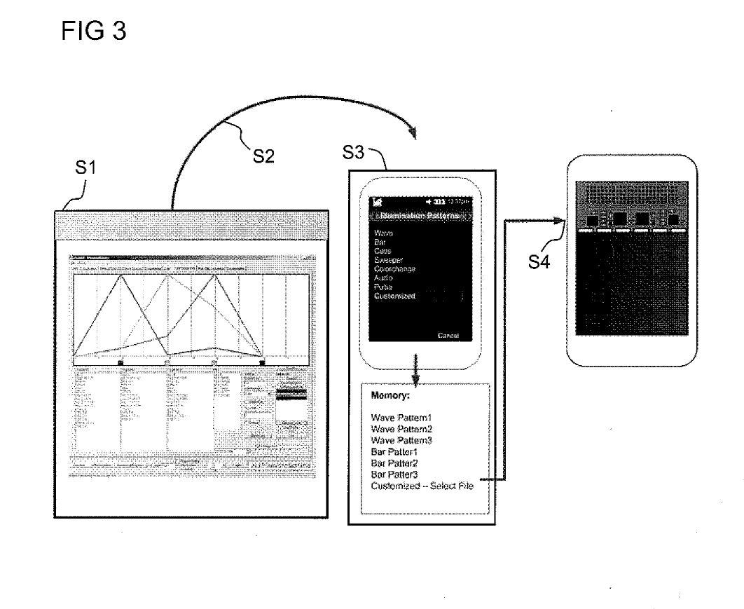

FIG. 3 shows an exemplary embodiment of a method according to the proposed principle.

FIG. 1 shows an exemplary embodiment of a system for downloading a light pattern according to the proposed principle. The system comprises a central unit 1, a terminal device 5 and a communications facility 7. The central unit 1 is realized as a computer or server, for example, that is located in a network. The central unit 1 comprises a memory 2 with at least one light pattern L, a control logic 3 and a communications interface 4. The memory 2 and the communications interface 4 are connected to the control logic 3. In addition, a device 6 for creating another light pattern is provided. It is likewise coupled to control logic 3.

The communications facility 7 comprises a mobile radio network, a conventional fixed network or an Internet.

The terminal device 5 has a communications interface 11 for connection to the communications facility 7.

A light pattern L stored in the memory 2 of the central unit 1 is transmitted with the aid of the control logic 3 and the communication interface 4 of the central unit 1 by the communications facility 7 and the communications interface 11 of the terminal device 5 to the latter. Additional light patterns are also generated with the device 6 of the central unit 1. A downloaded light pattern is assigned in the terminal device 5 to a defined application case and correspondingly executed.

The central unit 1 belongs, for example, to a mobile radio network operator or a device manufacturer or a chip manufacturer, which offers the downloading of light patterns as an additional service for subsequent configuration of an already supplied terminal device and for increasing ease of use.

Functionalities of the central unit 1 such as the control logic 3 and/or the device 6 for creating additional light patterns are implemented in this case, for example, as so-called Web services.

In a refinement, the central unit implements additional functions, such as acquisition of data that are required, for charging a fee for the downloading and/or creation of a light pattern.

FIG. 2 shows an exemplary embodiment of a terminal device according to the proposed principle. The terminal device 5 comprises a process control unit 10, the associated communications interface 11, a memory 12, a driver 13, a lighting device 14 connected thereto and a signal source 15. The driver 13, the memory 12 and the signal source 15 are connected to the control logic 10. The signal source 15 supplies a signal 16. The driver 13 provides a control signal 17 for the lighting device 14. The memory 12 comprises an already downloaded light pattern L.

The process control unit 10 overlays the signal 16 from the signal source 15 with the downloaded light pattern L from the memory 12. From this, the driver 13 generates the control signal 17 for the lighting device 14 of the terminal device. The signal 16 can comprise, for example, an audio signal, a sensor signal from an acceleration or motion sensor, or an event signal. An event can arrive via the communications network, or can be initiated directly or indirectly by an interaction of the user with the terminal device. The interaction can comprise, for example, an input at a keyboard, a scroll wheel, with a so-called slide joystick, or with a so-called softkey or the like. A direct interaction relates to the setting of a wake-up signal, for instance. The user has the opportunity in each case to set different light patterns for different application cases.

A remote configuration, particularly of the lighting device 14 of the terminal device 5, is advantageously made possible with the aid of the downloaded light pattern L.

In a refinement, the functions of the driver 13 and the process control unit 10 are implemented in a single unit.

FIG. 3 shows an exemplary embodiment of a method for downloading a light pattern according to the proposed principle. The method in this embodiment comprises a step S1, in which a light pattern is created on the central unit. A special editor is used for this purpose. The thus-prepared light pattern is stored in the memory of the central unit. In a second step S2, the thus-generated light pattern is downloaded via the communications facility from the central unit to the terminal device. This takes place, for example, by transmitting a corresponding file that contains the light pattern in a message transmitted with the aid of the Multimedia Message Service, for instance. In a third step S3, the downloaded light pattern is configured in the terminal device. For this purpose, a user selects the signal source with which the light pattern is to be connected in the future. In a fourth step S4, the appropriate light pattern is activated upon occurrence of an event configured for it, overlaid on the signal from the signal source and displayed on a terminal device with the aid of the lighting device.

### LIST OF REFERENCE NUMBERS

1 Central unit
2, 12 Memory
3 Control logic
4, 11 Communications interface
5 Terminal device
6 Device
7 Communications facility
10 Process control unit
13 Driver
14 Lighting device
15 Signal source
16 Signal
17 Control signal
L Light pattern
S1, . . . , S4 Step

1-13. (canceled)

14. A terminal device, particularly for use in a network, comprising:
a process control unit;
a communications interface, connected to the process control unit, that is set up for downloading at least one light pattern from the network;
a memory, connected to the process control unit, for storing the at least one light pattern;
a driver, connected to the process control unit, for providing a control signal for a lighting device; and
a signal source, coupled to the process control unit, for providing a signal,
wherein the terminal device is set up for executing the at least one light pattern,
wherein the signal source comprises a sensor and the signal comprises a sensor signal,
wherein the sensor is implemented as motion or acceleration sensor, and
wherein the control signal is provided as a function of an overlaying of the signal from the signal source with the light pattern from the memory.

15. The terminal device according to claim 14,
wherein the signal source comprises an audio unit and the signal comprises an audio signal.

16. The terminal device according to claim 14,
wherein the signal source comprises an event source and the signal comprises an event signal.

17. The terminal device according to claim 14,
wherein the terminal device is constructed as a portable device or a portable device with a connected computer.

18. A central unit for use in a network with at least one terminal device according to claim 14, the central unit comprising:
a memory for at least one light pattern suitable for running on the terminal device;
a control logic connected to the memory; and
a communications interface, connected to the control logic, for providing the at least one light pattern for the terminal device.

19. The central unit according to claim 18, further comprising a device connected to the control logic, for creating the at least one light pattern.

20. A system for downloading a light pattern, comprising:
a central unit, comprising:
a memory for at least one light pattern suitable for running on the terminal device;
a control logic connected to the memory; and
a communications interface, connected to the control logic, for providing the at least one light pattern for the terminal device;
a terminal device comprising:
a process control unit;
a communications interface, connected to the process control unit, that is set up for downloading at least one light pattern from the network;
a memory, connected to the process control unit, for storing the at least one light pattern;
a driver, connected to the process control unit, for providing a control signal for a lighting device; and
a signal source, coupled to the process control unit, for providing a signal,
wherein the terminal device is set up for executing the at least one light pattern,
wherein the signal source comprises a sensor and the signal comprises a sensor signal,
wherein the sensor is implemented as motion or acceleration sensor, and
wherein the control signal is provided as a function of an overlaying of the signal from the signal source with the light pattern from the memory, and
a communications facility for transmitting the at least one light pattern from the communications interface of the central unit to the communications interface of the terminal device.

21. A method for downloading a light pattern comprising the steps of:
connecting a terminal device to a central unit via a communications facility;
selecting a light pattern stored in the central unit;
downloading the selected light pattern from the central unit to the terminal device via the communications facility; and
storing the downloaded light pattern on the terminal device;
configuring the light pattern on the terminal device;
linking the light pattern to a signal from a signal source and generating a control signal for a lighting device of the terminal device, wherein the control signal is generated as a function of an overlaying of the signal with the light pattern and wherein the signal comprises a sensor signal of a signal source which is implemented as motion or acceleration sensor.

22. The method according to claim 21, further comprising a creation of an additional light pattern.
